(19) United States
(12) Patent Application Publication
(10) Pub. No.: US 2014/0200109 A1
(43) Pub. Date: Jul. 17, 2014

(54) Planetary Gear Pump

(71) Applicant: Leo James Stocco, Vancouver (CA)

(72) Inventor: Leo James Stocco, Vancouver (CA)

(21) Appl. No.: 14/153,084

(22) Filed: Jan. 13, 2014

Related U.S. Application Data
(60) Provisional application No. 61/752,046, filed on Jan. 14, 2013.

(51) Int. Cl. F16H 1/28

(52) U.S. Cl. CPC F16H 1/28
USPC 475/331

(57) ABSTRACT

A planetary gear pump comprising a central gear and a plurality of planet pairs provides a space efficient transducer between hydraulic and mechanical energy. When it is configured as a pump, a high flow rate is provided. When it is configured as an actuator, a high torque is provided. A dual-stage configuration may be used as a low speed high torque actuator with high energy efficiency, high pitch velocity, and low slippage.

This application claims priority to U.S. Provisional Application No. U.S. 61/752,046 filed Jan. 14, 2013. This patent application is incorporated herein entirely by reference.

### TECHNICAL FIELD

This disclosure herein relates to a fluid pump or fluid driven actuator comprising a plurality of gears.

### BACKGROUND

Existing gear pumps typically come in a conventional configuration or a planetary configuration. The conventional configuration comprises two spur gears with parallel rotation axes. The gears are mounted in a sealed housing and engage in the center. When the gears are rotated, fluid is captured by the voids between gear teeth and is transferred from one side of the chamber to the other. The central return path is blocked by the engaging gear teeth which fill the voids that are otherwise occupied by fluid. Since engaged gears counter-rotate, both gears provide for fluid flow in a common direction.

The planetary configuration comprises a central sun gear and typically three planet gears, each with parallel rotation axes. The gears are mounted in a sealed housing with the planet gears arranged radially and equally spaced around the centrally located sun gear. Each planet gear is engaged with the sun gear. When the sun gear is rotated, fluid is captured by the voids between gear teeth and is transferred from one side of each planet gear to the other. Since all planet gears rotate in a common direction, a chamber is provided to join the clockwise sides of all planet gears, and another chamber is provided to join the anti-clockwise side of all planet gears.

A gear pump is a simple, energy efficient, positive displacement transducer between fluid and mechanical energy. It may be operated in a forward or reverse direction, or be used as a hydraulic actuator where high pressure fluid is used to drive a mechanical load.

One disadvantage of a gear pump is an unfavorable ratio between the transmitted fluid volume and the corresponding number of drive shaft turns that is a consequence of the necessarily small space between gear teeth. Improving the associated volume/turn ratio requires increasing the size of the pump since the volume of the voids between gear teeth is proportional to the cross-sectional area and depth of the gear.

Another disadvantage of a gear pump is the relatively high fluid slippage that is a consequence of an imperfect seal between the outer perimeter of the gears and the case. Since the percentage of power lost to slippage is inversely proportional to pitch velocity, gear pumps and actuators are not well suited to applications with low (<500 RPM) shaft speeds.

The exemplary embodiments disclosed herein each comprise a central sun and/or orbit gear and two or more pairs of planet gears. The planet gears are arranged whereby all planet gears direct fluid between the perimeter and center of the pump/actuator for improved space efficiency over the prior art. The gear pairs may be arranged to provide out of phase pumping action to minimize pulsing or to include multiple drive shafts that turn at different speeds in the same or opposite directions. Two pumps may be arranged in parallel to amplify shaft torque and/or fluid flow. A hollow shaft actuator may be used to provide a cylindrical actuated pump with an intake on one side, and an exhaust port on the other. Alternate configurations comprise rotors, a manifold and a dual-stage configuration for improved space efficiency and other desirable characteristics.

### SUMMARY

Certain exemplary embodiments comprise a carrier member, one or more planet pairs, and a central gear. The carrier member defines a central axis and comprises a first and second plane which are substantially parallel to each other and perpendicular to the central axis. The space between the first and second plane defines an interior space. The carrier member further comprises one or more passageways from the exterior of the carrier member to the interior space. All planet pairs are arranged circumferentially and substantially equally spaced around the central axis. Each planet pair comprises a first planet gear and a second planet gear. Each planet gear is rotatably coupled to the carrier member about a corresponding first or second planet axis. Each planet axis is substantially parallel to the central axis. The central gear is rotatably coupled to the carrier member about the central axis. Each first planet gear simultaneously engages the central gear and the second planet gear from the corresponding planet pair.

In certain exemplary embodiments, each planet gear is sandwiched between the first and second plane.

Certain exemplary embodiments further comprise a plurality of elongated seal members. Each seal member is integral with the carrier member and extends from the first plane to the second plane. Each seal member comprises one or more semi-circular surfaces describing the circumference of an adjacent gear.

Certain exemplary embodiments further comprise a plurality of rotors, the number of rotors being equal to the number of planet gears. Each rotor is integral, and configured to rotate in unison with a planet gear. Each rotor is sandwiched between the first and second plane. Each pair of rotors that are integral with a pair of engaged gears, are also engaged.

Certain exemplary embodiments further comprise a plurality of elongated seal members. Each seal member is integral with the carrier member and extends from the first plane to the second plane. Each seal member comprises one or more semi-circular surfaces describing the circumference of an adjacent rotor.

In certain exemplary embodiments, the central gear is a ring gear that encircles all planet gears.

In certain exemplary embodiments, one or more passageways are located between the central axis and the engagement point between a first and second planet gear.

In certain exemplary embodiments, the central gear is a pinion gear that is encircled by all planet gears.

In certain exemplary embodiments, one or more passageways are located between the central gear and the engagement point between a first and second planet gear.

In certain exemplary embodiments, the number of planet pairs is greater than one and each first planet gear engages the second planet gear from an adjacent planet pair.

Certain exemplary embodiments further comprise a collection chamber and a plurality of passageways. The collection chamber comprises a port between the interior and exterior of the collection chamber. Each passageway joins the engagement point between a pair of engaged gears to the collection chamber.

Certain exemplary embodiments further comprise a second central gear. The second central gear is rotatably coupled to the carrier member about the central axis. The second central gear simultaneously engages all second planet gears.

Certain exemplary embodiments comprise a carrier member, one or more first planet pairs, an equal number of second planet pairs, a first central gear, and a second central gear. The carrier member defines a central axis and comprises a first, second, third and fourth plane which are all substantially parallel to each other and perpendicular to the central axis. The space between the first and second plane define a first interior space. The space between the third and fourth plane define a second interior space. The carrier member further comprises one or more passageways from the exterior of the carrier member to the first interior space and one or more passageways from the exterior of the carrier member to the second interior space. The carrier member further comprises a plurality of elongated seal members, each extending from the first plane to the second plane and comprising one or more semi-circular surfaces describing the circumference of an adjacent gear. The carrier member further comprises a plurality of elongated seal members, each extending from the third plane to the fourth plane and comprising one or more semi-circular surfaces describing the circumference of an adjacent gear. All first planet pairs and all second planet pairs are arranged circumferentially and substantially equally spaced around the central axis. Each first planet pair comprises a first planet gear and a second planet gear. Each second planet pair comprises a third planet gear and a fourth planet gear. Each planet gear is rotatably coupled to the carrier member about a corresponding first, second, third or fourth planet axis. Each planet axis is substantially parallel to the central axis. Each central gear is rotatably coupled to the carrier member about the central axis. Each first and second planet gear is sandwiched between the first and second plane. Each third and fourth planet gear is sandwiched between the third and fourth plane. Each first planet gear simultaneously engages the first central gear and the second planet gear from the corresponding planet pair. Each third planet gear simultaneously engages the second central gear and the fourth planet gear from the corresponding planet pair.

In certain exemplary embodiments, each first planet axis is coaxial with a third planet axis and each first planet gear is integral and configured to rotate in unison with the corresponding coaxial third planet gear.

In certain exemplary embodiments, each first planet axis is coaxial with a fourth planet axis and each first planet gear is integral and configured to rotate in unison with the corresponding coaxial fourth planet gear.

In certain exemplary embodiments, each second planet axis is coaxial with a fourth planet axis and each second planet gear is integral and configured to rotate in unison with the corresponding coaxial fourth planet gear.

In certain exemplary embodiments, a method is disclosed. A carrier member is provided comprising a first and second plane which are substantially parallel to each other and define a first interior space and further comprising one or more passageways from the exterior of the carrier member to the first interior space. The carrier member is located on a central axis whereby the first plane is substantially perpendicular to the central axis. One or more first planet pairs are provided, each comprising a first planet gear and a second planet gear. All first planet pairs are located circumferentially and substantially equally spaced around the central axis, whereby all planet gears are parallel to the central axis and sandwiched between the first and second plane. Each planet gear is rotatably coupled to the carrier member about a corresponding first or second planet axis. A first central gear is provided. The first central gear is rotatably coupled to the carrier member about the central axis. Each first planet gear is simultaneously engaged with the first central gear and the second planet gear from the corresponding planet pair.

In certain exemplary embodiments, a plurality of elongated seal members are provided, each extending from the first plane to the second plane, each comprising one or more semi-circular surfaces that describe the circumference of an adjacent gear.

In certain exemplary embodiments, at least two first planet pairs are provided. Each first planet gear is engaged with the second planet gear from an adjacent planet pair. A collection chamber is provided comprising a port between the interior and exterior of the collection chamber. A passageway is provided from the engagement point between each pair of engaging gears and the collection chamber.

In certain exemplary embodiments, the carrier member is provided with a third and fourth plane which are substantially parallel to the first plane and define a second interior space, and one or more passageways from the exterior of the carrier member to the second interior space. One or more second planet pairs are provided, each comprising a third planet gear and a fourth planet gear. All second planet pairs are located circumferentially and substantially equally spaced around the central axis, whereby all planet gears are parallel to the central axis and sandwiched between the third and fourth plane. Each third and fourth planet gear is rotatably coupled to the carrier member about a corresponding third or fourth planet axis. A second central gear is provided. The second central gear is rotatably coupled to the carrier member about the central axis. Each third planet gear is simultaneously engaged with the second central gear and the fourth planet gear from the corresponding planet pair. A plurality of elongated seal members are provided, each extending from the third plane to the fourth plane, each comprising one or more semi-circular surfaces that describe the circumference of an adjacent gear.

### BRIEF DESCRIPTION OF DRAWINGS

FIGS. 1A-1E depict respectively, a perspective view, a partial front view, an exploded perspective view, a second exploded perspective view, and a second partial front view in accordance with a first exemplary embodiment of a planetary gear pump.

FIG. 2 depicts a partial front view in accordance with a second exemplary embodiment of a planetary gear pump.

FIGS. 3A-3D depict respectively, a perspective view, a partial front view, a front view, and an exploded perspective view in accordance with a third exemplary embodiment of a planetary gear pump.

FIGS. 4A-4E depict respectively, a perspective view, a partial front view, a front view, a cross-sectional side view, and an exploded perspective view in accordance with a fourth exemplary embodiment of a planetary gear pump.

FIGS. 5A-5C depict respectively, a perspective view, a partial front view, and an exploded perspective view in accordance with a fifth exemplary embodiment of a planetary gear pump.

FIG. 6 depicts a partial front view in accordance with a sixth exemplary embodiment of a planetary gear pump.

FIGS. 7A-7C depict respectively, a perspective view, a cross-sectional side view, and an exploded perspective view in accordance with a first exemplary embodiment of an actuated planetary gear pump.

FIGS. 8A-8B depict respectively, a partial front view, and a second partial front view in accordance with a first exemplary embodiment of a planetary rotor pump.

FIGS. 9A-9E depict respectively, a perspective view, a front view, a partial front view, a second partial front view, and an exploded perspective view in accordance with a seventh exemplary embodiment of a planetary gear pump.

FIGS. 10A-10C depict respectively, a partial front view, a second partial front view, and a third partial front view in accordance with a second exemplary embodiment of a planetary rotor pump.

FIGS. 11A-11G depict respectively, a perspective view, a cross-sectional side view, a front view, a rear view, a partial front view, a second partial front view, and a perspective exploded view in accordance with a first exemplary embodiment of a dual-stage planetary gear pump.

### REFERENCE NUMERALS

1—axis
2—planet axis
7—rotation
8—rotation
9—flow
10—pump
11—carrier assembly
12—planet pair
13—rotor pump
14—timing gear assembly
21—planet gear
22—orbit gear
23—orbit gear
24—sun gear
25—rotor
30—port
31—port
32—port
33—seal
34—scoop
41—drive shaft
42—drive shaft
43—carrier shaft
44—carrier member
50—case
51—stator
52—drive member
53—manifold
61—bearing
63—bearing
64—bearing
65—bearing

### DESCRIPTION OF EMBODIMENTS

Wherever possible, the same reference numerals are used throughout the accompanying drawings and descriptions to refer to the same or like parts. Components such as retainers, fasteners or seals that do not substantially contribute to the functionality of the embodiments disclosed herein are assumed and neglected for the sake of simplicity.

Although spur gears are used as exemplary engaging members and pumping elements in the accompanying drawings, it is understood that many other means would suffice, such as spiral gears, helical gears, double helical gears, herring-bone gears and roller tooth gears.

Although rotors with epicycloid and hypocycloid lobes are used as exemplary rotor pumping elements in the accompanying drawings, it is understood that any non-circular, geometries for which the radii of neighboring elements sum to a constant over the entire rotation range would suffice.

Although a particular tooth module is depicted in the accompanying drawings, it is understood that any module will suffice as long as all pairs of engaging gears have equivalent modules.

Although a straight tooth profile is depicted in the accompanying drawings, it is understood that any tooth profile will suffice, such as an involute profile with any desired pressure angle. It is also understood that any number of different tooth profiles may be used as long as all pairs of engaging gears have complementary tooth profiles.

It is understood that a spur gear comprises teeth arranged circumferentially on a cylindrical hub with a substantially uniform tooth profile. It is also understood that a ring gear engages on its interior surface and a pinion gear engages on its exterior surface.

Although bearings are used to depict rotatable couplings in the accompanying drawings, it is understood that any other means will suffice, such as roller bearings, plain or journal bearings, thrust bearings, low friction coatings, materials or surface treatments or favorable clearances and lubricants. It is also understood that the male and female members making up a rotatable coupling may often be interchanged without substantially affecting functionality. It is also understood that rotatably coupling a first member to a second member which is also rotatably coupled to a third member about a common axis, is equivalent to rotatably coupling the first member to the third member.

Although shafts are used to depict rotational inputs and outputs in the accompanying drawings, it is understood that any other means will suffice, such as eccentric or crank shafts, gears, friction couplings, pulleys, sprockets, female couplings, fastener interfaces such as keyways or threaded holes, or materials, circuits or assemblies providing a magnetic or electrostatic interface.

Any members that are described as integral in the following description are fixably connected. Although posts are also used to depict fixable connections in the accompanying drawings, it is understood that any other means will suffice, such as welds, fasteners, elongated members of any cross-sectional shape, or forming the integral parts from a single piece of material.

Although each exemplary embodiment is depicted as a pump, a person skilled in the art will appreciate that a pump may be used as an actuator by interchanging the roles of the input and output. It is also understood that any hydraulic pump or actuator may be used as a pneumatic pump or actuator. A pump or actuator may be used in association with positive pressure or vacuum using any fluids including gases, liquids and slurries. All combinations are anticipated.

A representative sample of embodiments is included in the accompanying figures for exemplary purposes only. A great number of additional tooth geometries, ring and pinion combinations and kinematic arrangements are also contemplated. The scope of the present invention is not limited to the embodiments included but spans all possible combinations anticipated by the specification and claims.

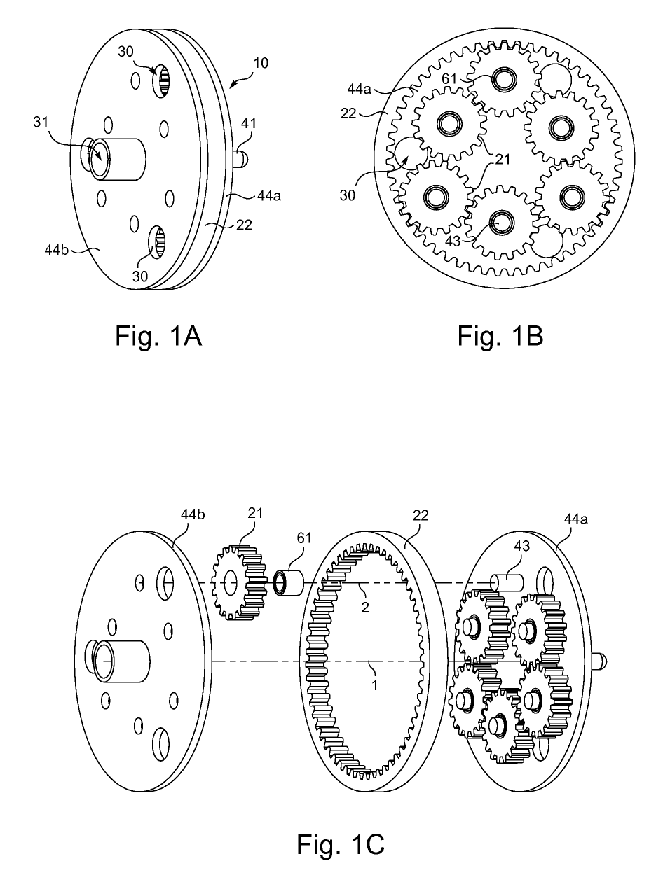

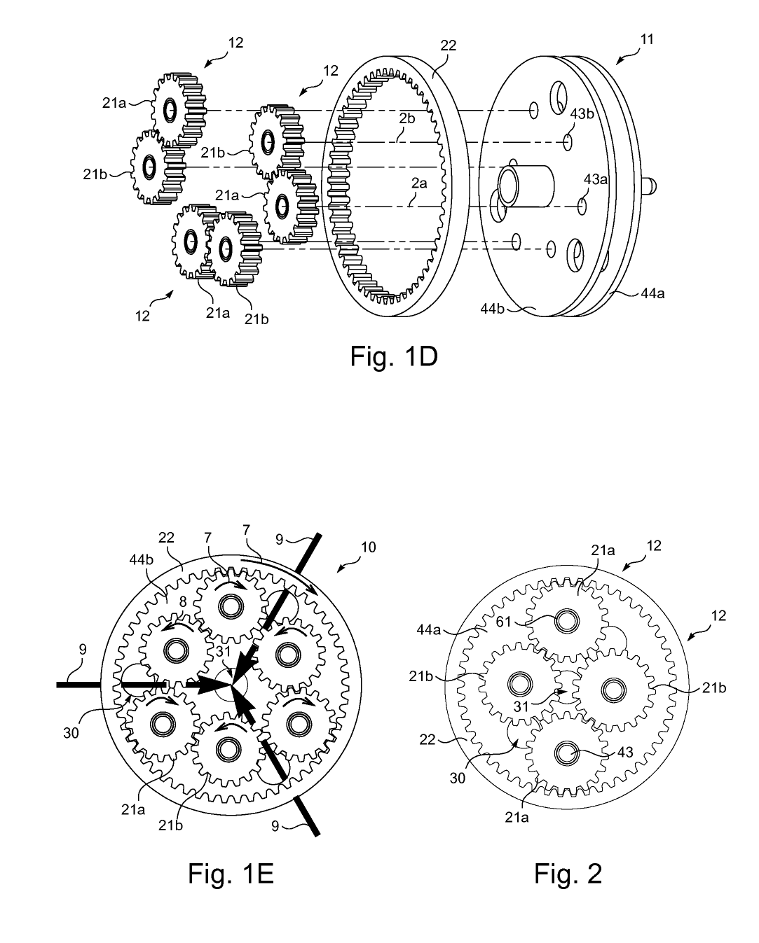

FIG. 1 illustrates a first exemplary embodiment of a planetary gear pump 10 which provides flow from a plurality of inlet ports 30 to an outlet port 31 and positive pressure at port 31, when a drive shaft 41 is rotated in a particular direction. Reversing the direction of drive shaft 41 provides flow from port 31 to ports 30 and vacuum at port 31. Alternatively, the planetary gear pump 10 may operate as an actuator. Providing positive pressure at port 31 causes drive shaft 41 to rotate in a particular direction and providing vacuum at port 31 causes drive shaft 41 to rotate in the opposite direction.

The planetary gear pump 10 comprises an orbit gear 22, a carrier assembly 11, and a plurality of planet pairs 12. The orbit gear 22 and carrier assembly 11 are axially aligned and rotatably coupled about a central axis 1. For the sake of simplicity, the rotatable coupling between orbit gear 22 and carrier assembly 11 is not depicted in FIG. 1. In practice, orbit gear 22 would be integral with a case and carrier assembly 11 would be rotatably coupled to the case using bearings or other means.

The carrier assembly 11 comprises a first carrier member 44a, a second carrier member 44b, a plurality of first carrier shafts 43a, each defining a first planet axis 2a, and a plurality of second carrier shafts 43b, each defining a second planet axis 2b. All first and all second carrier shafts 43a, 43b are parallel to, and spaced uniformly from the central axis 1 with the first carrier shafts 43a spaced further from the central axis 1 than the second carrier shafts 43b.

There are an equal number of planet pairs 12, first carrier shafts 43a, and second carrier shafts 43b. Each planet pair 12 comprises a first planet gear 21a and a second planet gear 21b, each co-axial and rotatably coupled to a corresponding carrier shaft 43a, 43b, by a bearing 61.

The first carrier member 44a comprises a drive shaft 41 and a plurality of inlet ports 30. The second carrier member 44b comprises a plurality of inlet ports 30 and an outlet port 31. The planet gears 21 are sandwiched between the first and second carrier members 44a and 44b with sufficient clearance to prevent a substantial amount of fluid from flowing between the planet gears 21 and the carrier members 44.

The first and second planet gears 21a, 21b in each planet pair 12 engage each other and all first planet gears 21a engage the orbit gear 22. The perimeter of each first planet gear 21a is substantially tangential to, and in rolling contact with the perimeter of the second planet gear 21b from the neighboring planet pair 12, with no engagement between the associated gear teeth.

As illustrated in FIG. 1E, rotating orbit gear 22 in a clockwise direction 7 with respect to carrier 44, causes all first planet gears 21a to rotate in a clockwise direction 7 and all second planet gears 21b to rotate in an anti-clockwise direction 8. The voids between the counter-rotating teeth of planet gears 21 from neighboring planet pairs 12 cause fluid to flow 9 in through inlet ports 30, between gears 21a and 21b and out through outlet port 31. Positive pressure is developed at port 31. It is understood that this is equivalent to rotating drive shaft 41 in an anti-clockwise direction with respect to orbit gear 22.

FIG. 2 illustrates a second exemplary embodiment of a planetary gear pump 10. The second exemplary embodiment is substantially equivalent to the first exemplary embodiment illustrated in FIG. 1, except the second exemplary embodiment comprises two planet pairs 12 rather than three.

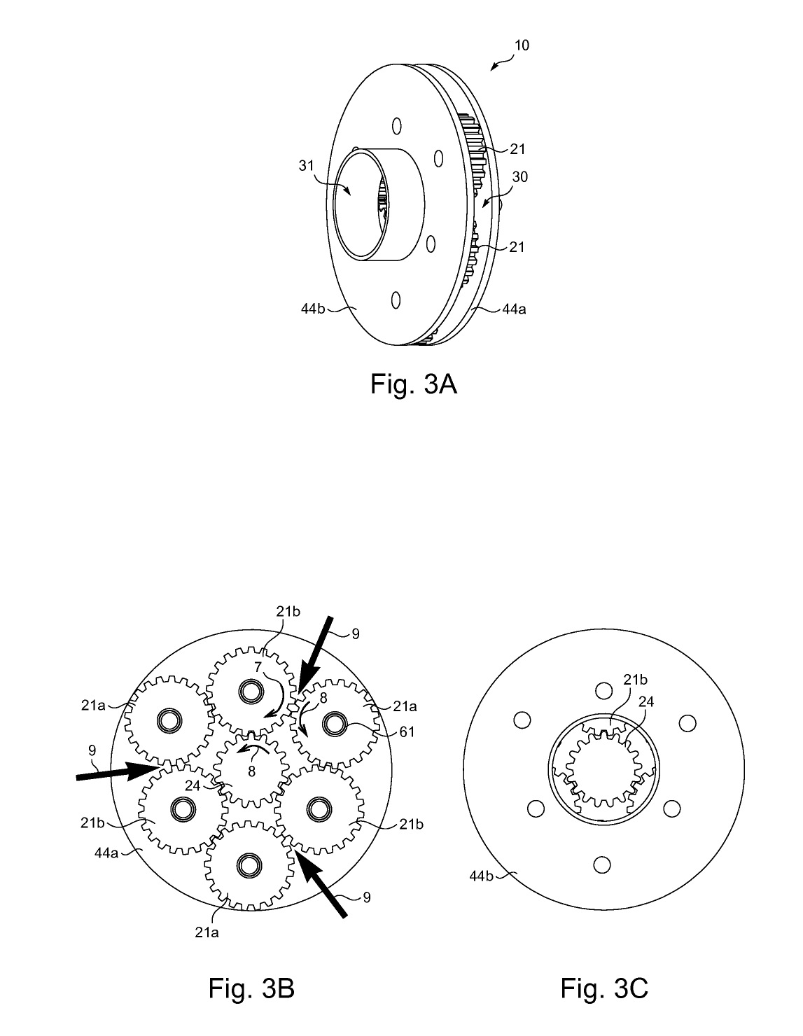

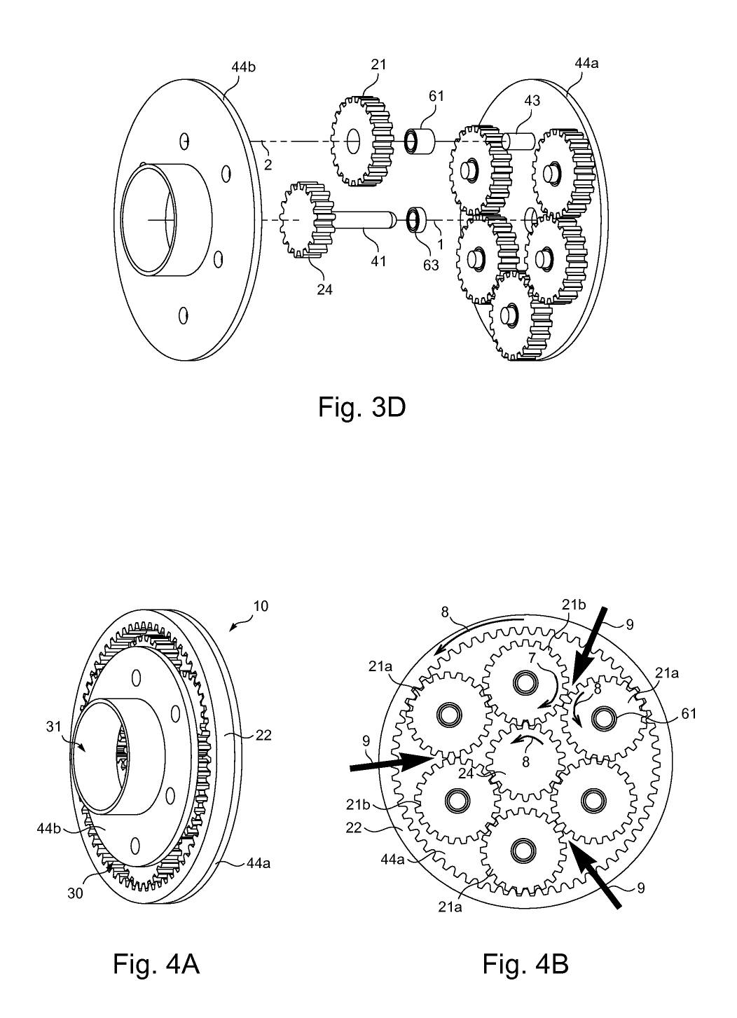

FIG. 3 illustrates a third exemplary embodiment of a planetary gear pump 10. The third exemplary embodiment is substantially equivalent to the first exemplary embodiment illustrated in FIG. 1, except for the following. In the third exemplary embodiment, the ring orbit gear 22 is replaced by a pinion sun gear 24. Sun gear 24 is rotatably coupled to the first carrier member 44a about axis 1 by a bearing 63. The sun gear 24 simultaneously engages all second planet gears 21b. Neither carrier member 44 comprises any inlet ports. The diameter of outlet port 31 is larger than the outside diameter of the sun gear 24 to provide a path for fluid to flow out through port 31.

As illustrated in FIG. 3B, rotating sun gear 24 in an anti-clockwise direction 8 causes second planet gears 21b rotate in a clockwise direction 7 and first planet gears 21a to rotate in an anti-clockwise direction 8, causing fluid to flow 9 from the perimeter to the center of the planetary gear pump 10.

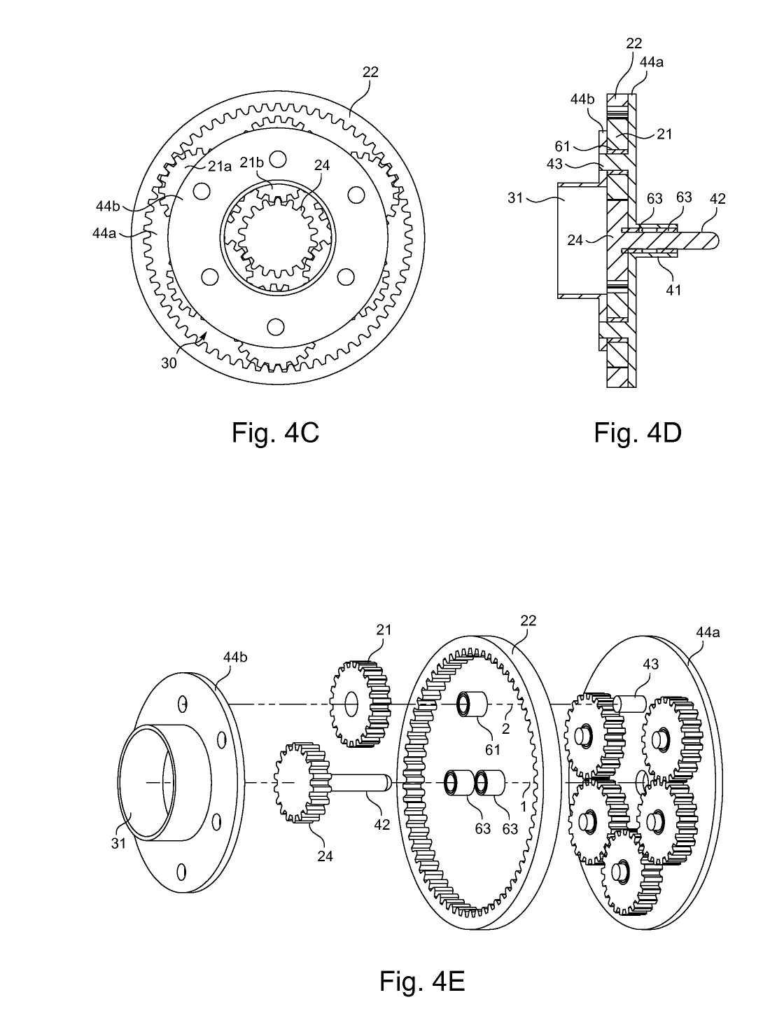

FIG. 4 illustrates a fourth exemplary embodiment of a planetary gear pump 10. The fourth exemplary embodiment is substantially equivalent to the first exemplary embodiment illustrated in FIG. 1, except for the following. The fourth exemplary embodiment further comprises a pinion sun gear 24. Sun gear 24 is rotatably coupled to the first carrier member 44a about axis 1 by a pair of bearings 63. The sun gear 24 comprises a second drive shaft 42 and simultaneously engages all second planet gears 21b. In addition, the diameter of second carrier member 44b is reduced to provide a single inlet port 30 that spans the perimeter of second carrier member 44b. In addition, the diameter of outlet port 31 is larger than the outside diameter of the sun gear 24 to provide a path for fluid to flow out through port 31.

As illustrated in FIG. 4B, rotating orbit gear 22 in an anti-clockwise direction 8, causes first planet gears 21a to rotate in an anti-clockwise direction 8, second planet gears 21b to rotate in a clockwise direction 7, and sun gear 21 to rotate in an anti-clockwise direction 8, causing fluid to flow 9 from the perimeter of the second carrier member 44b, to the center of the planetary gear pump 10. Providing positive or negative pressure at port 31 causes drive shaft 41 and drive shaft 42 to simultaneously rotate at different speeds, with respect to orbit gear 22, thereby providing a dual-speed hydraulic actuator.

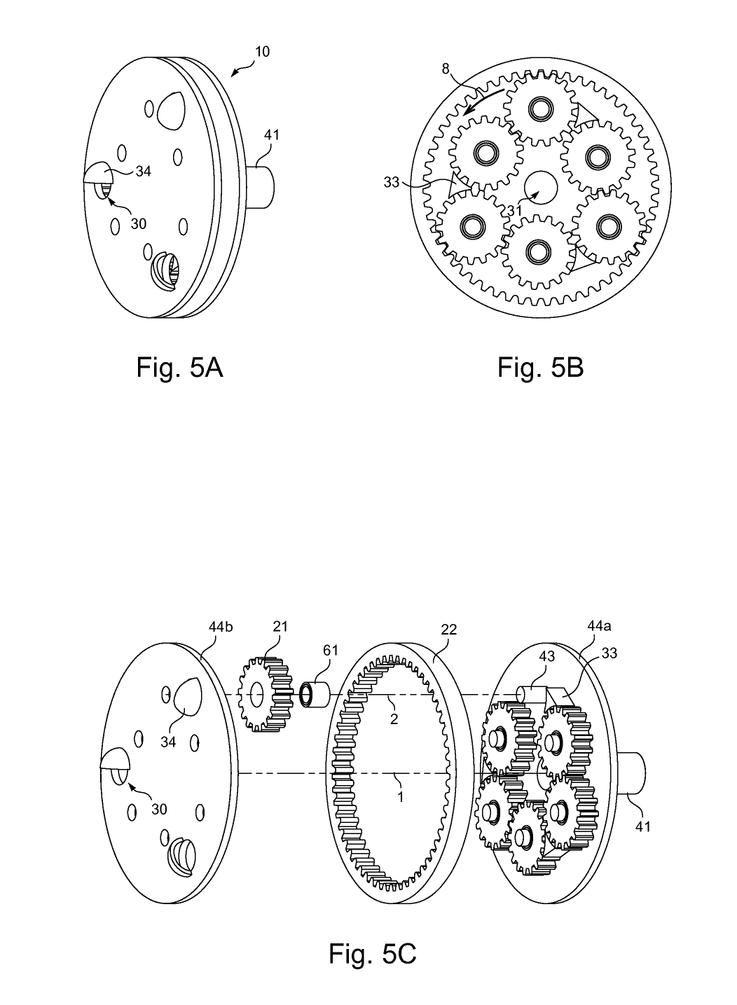

FIG. 5 illustrates a fifth exemplary embodiment of a planetary gear pump 10. The fifth exemplary embodiment is substantially equivalent to the first exemplary embodiment illustrated in FIG. 1, except for the following. In the fifth exemplary embodiment, the first carrier member 44a does not comprise any inlet ports. All inlet ports 30 are located on the second carrier member 44b, which further comprises a scoop 34 over each port 30 to direct fluid into the corresponding port 30 when the carrier assembly 11 is rotated in an anti-clockwise direction 8. In addition, the outlet port 31 is integrated into the drive shaft 41, whereby fluid enters the planetary gear pump 10 from the front side of the pump and exits out the back side of the pump. In addition, carrier member 44a further comprises a plurality of seals 33 that follow the circumference of each planet gear 21 to provide improved resistance to backflow of fluid, particularly when the pump is stationary.

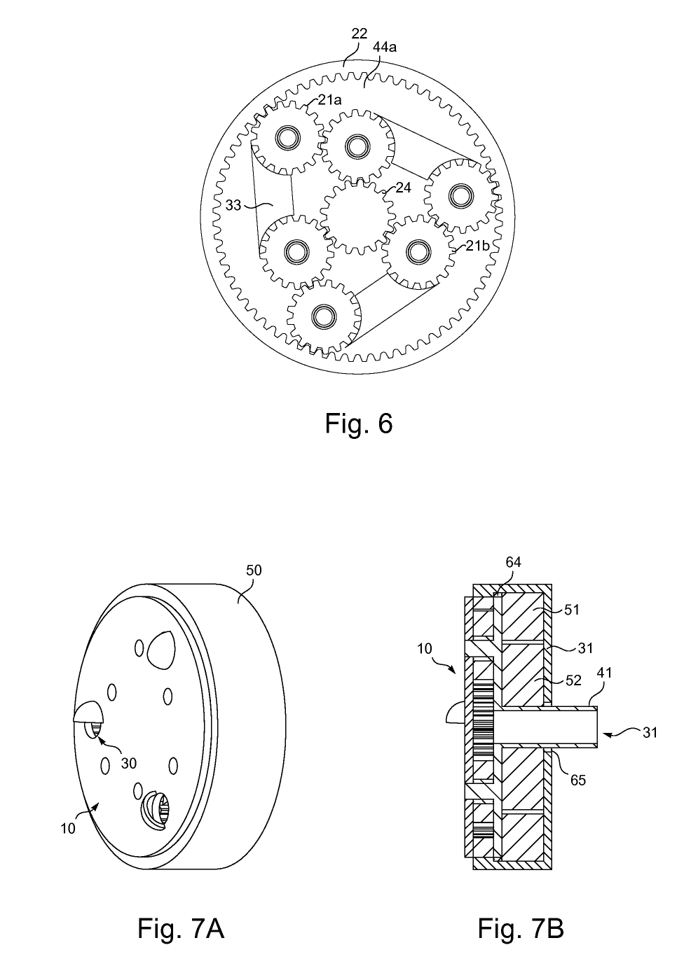

FIG. 6 illustrates a sixth exemplary embodiment of a planetary gear pump 10. The sixth exemplary embodiment is substantially equivalent to the fourth exemplary embodiment illustrated in FIG. 4, except for the following. In the sixth exemplary embodiment, carrier member 44a further comprises a plurality of seals 33 that follow the circumference of each planet gear 21 to provide improved resistance to backflow of fluid, particularly when the pump is stationary. In addition, these seals allow the planet gears 21 to be configured whereby the portions of the gears that deliver fluid to the center of the pump are out of phase with each other to reduce pulsing of the fluid flow.

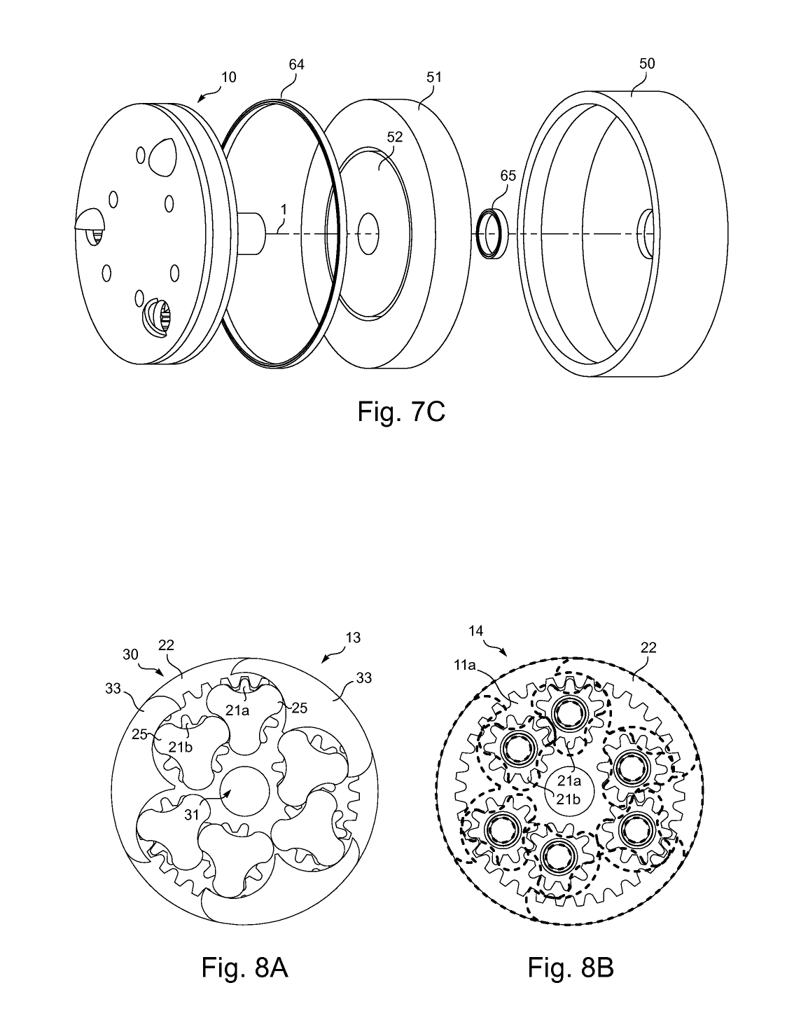

FIG. 7 illustrates a first exemplary embodiment of an actuated planetary gear pump whereby fluid enters the pump from the front side of the pump and exits out the back side of the pump. The pump comprises a case 50, a stator 51, a drive member 52 and a fifth embodiment of a planetary gear pump 10, all co-axial with a central axis 1. The stator 51 is integral with the case 50. The rotor is integral with the drive shaft 41 of the pump 10. The orbit gear 22 of the pump 10 is integral with the case 50. The carrier assembly 11 is rotatably coupled to the case by a bearing 64 and a bearing 65.

When the actuator is activated, a torque is imparted between the drive member 52 and the stator 51, which rotates the carrier assembly 11 of the pump 10, with respect to the case 50. Fluid is pumped into ports 30, through drive shaft 41 and out port 31. The envelope of the actuated pump is cylindrical with fluid entering one face of the cylinder and exiting the opposite face of the cylinder. The resulting geometry is advantageous in certain applications involving confined spaces.

FIG. 8 illustrates a first exemplary embodiment of a planetary rotor pump 13 which provides flow from a plurality of inlet ports 30 to an outlet port 31, resulting in positive pressure at port 31, when a drive shaft 41 is rotated. The planetary rotor pump 13 is substantially equivalent to the first exemplary embodiment of a planetary gear pump 10 illustrated in FIG. 1, with each planet gear 21 integral and rotating in unison with a rotor 25. In addition, the seals 33 follow the circumference of each rotor 25 to provide resistance to backflow of fluid since the orbit gear 22 and planet gears 21 act as a timing gear assembly 14 and the rotors 25 act as pumping elements.

The planet gears 21 are depicted as being visible in FIG. 8a for exemplary purposes only. In practice, they would normally be located below the rotors 25 with a sealing layer sandwiched between the planet gears 21 and rotors 25 to prevent fluid from coming into contact with the planet gears 21. Although the planetary rotor pump 13 depicted in FIG. 8 is based on the first exemplary embodiment of a planetary gear pump 10, any exemplary embodiment of a planetary gear pump 10 would suffice.

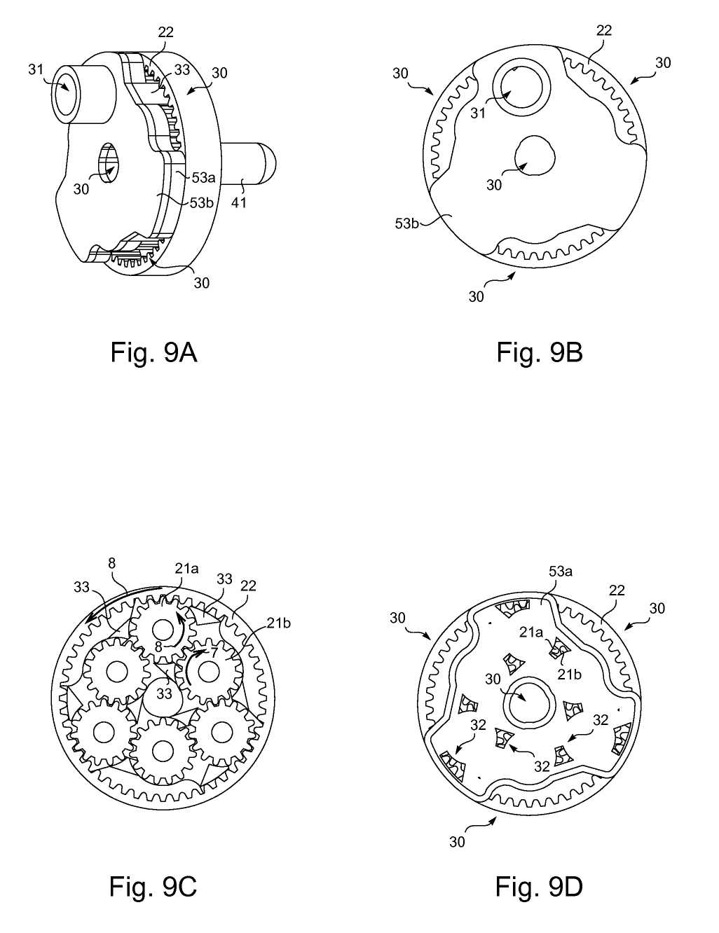

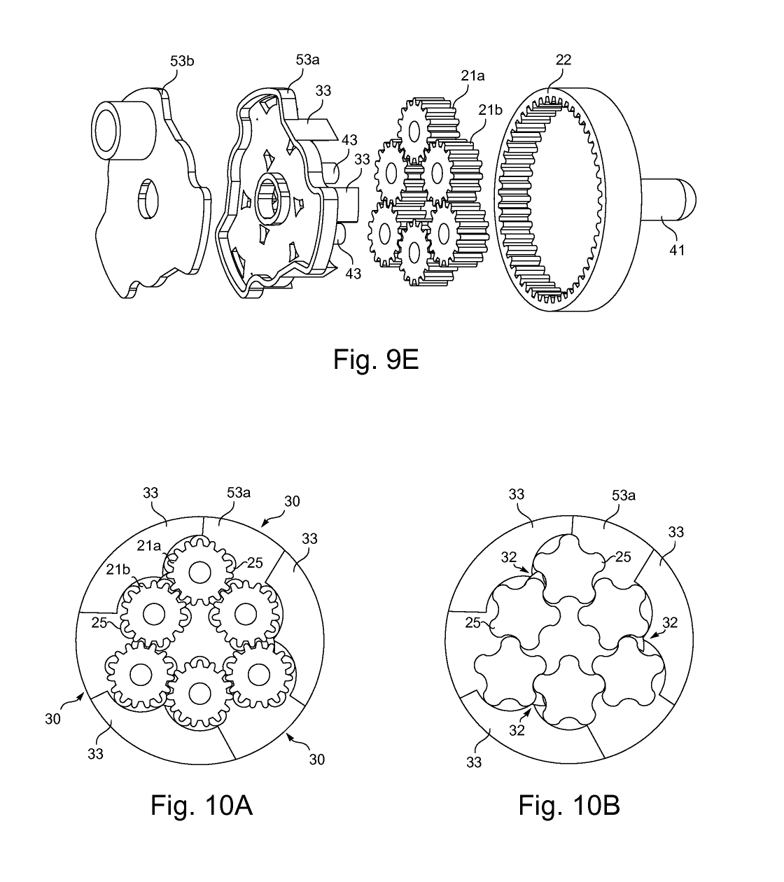

FIG. 9 illustrates a seventh exemplary embodiment of a planetary gear pump 10. The seventh exemplary embodiment is substantially equivalent to the first exemplary embodiment illustrated in FIG. 1, except for the following. Carrier 44 is replaced by a manifold 53 comprising a plurality of seals 33, and a plurality of inlet ports 30 leading to a semi-enclosed chamber, and finally leading to outlet port 31. In addition, each planet gear 21a, 21b simultaneously engages both neighboring planet gears 21a, 21b. The four inlet ports 30 depicted include three on the perimeter of the manifold 53 and one in the center of the manifold 53. A seal 33 is placed at the leading edge of every engagement point between all engaging planet gears 21 and all planet gears 21 engaging the orbit gear 22.

Rotating orbit gear 22 in an anti-clockwise direction 7 causes all first planet gears 21a to rotate in an anti-clockwise direction, and all second planet gears 21b to rotate in a clockwise direction. As the corresponding gear teeth come into engagement, the fluid occupying the voids between gear teeth is compressed and directed into the semi-enclosed manifold 53 through ports 32, creating positive pressure inside the manifold 53. The resulting pressure causes fluid to exit the manifold 53 through port 31. The seals 33 and ports 32 are configured to prevent fluid from flowing in the opposite direction.

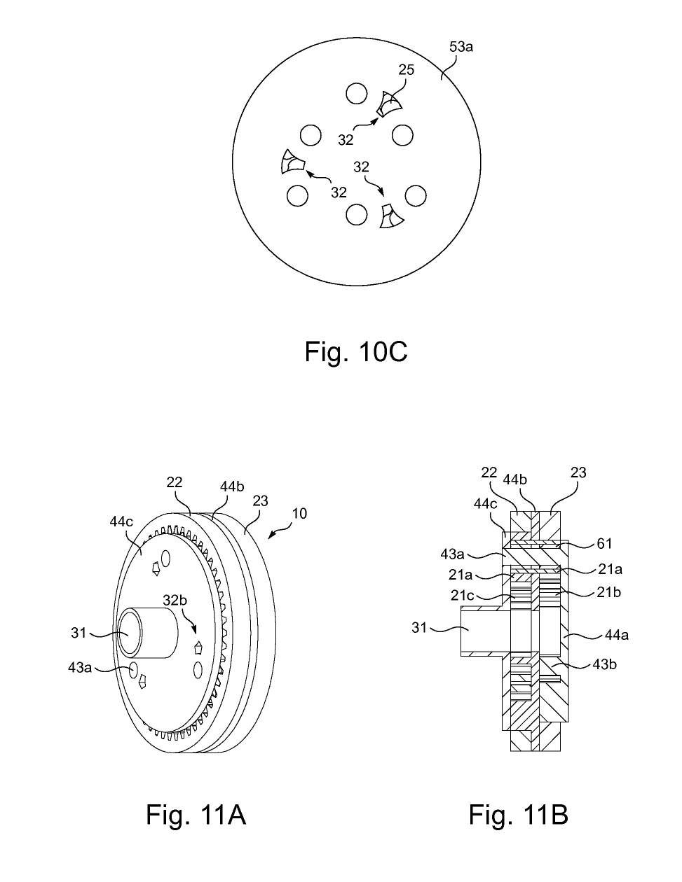

FIG. 10 illustrates a second exemplary embodiment of a planetary rotor pump 13 which provides flow from a plurality of inlet ports 30 to a plurality of outlet ports 32, resulting in positive pressure at the ports 32, when a drive shaft 41 is rotated. The planetary rotor pump 13 is substantially equivalent to the seventh exemplary embodiment of a planetary gear pump 10 illustrated in FIG. 9, with each planet gear 21 integral and rotating in unison with a rotor 25. In addition, the seals 33 follow the circumference of each rotor 25 to provide resistance to backflow of fluid since the orbit gear 22 and planet gears 21 act as a timing gear assembly 14 and the rotors 25 act as pumping elements.

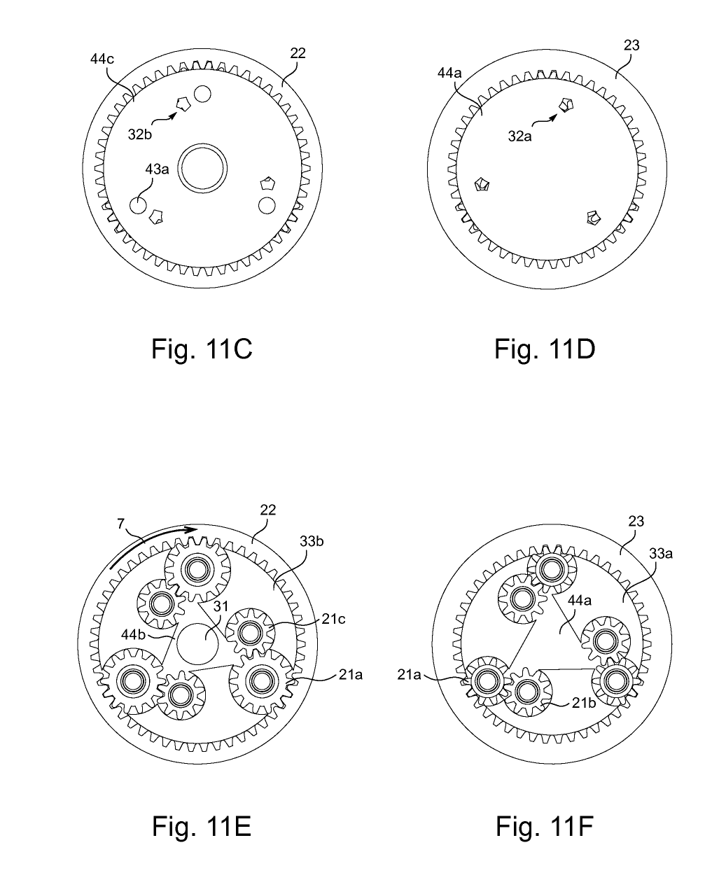

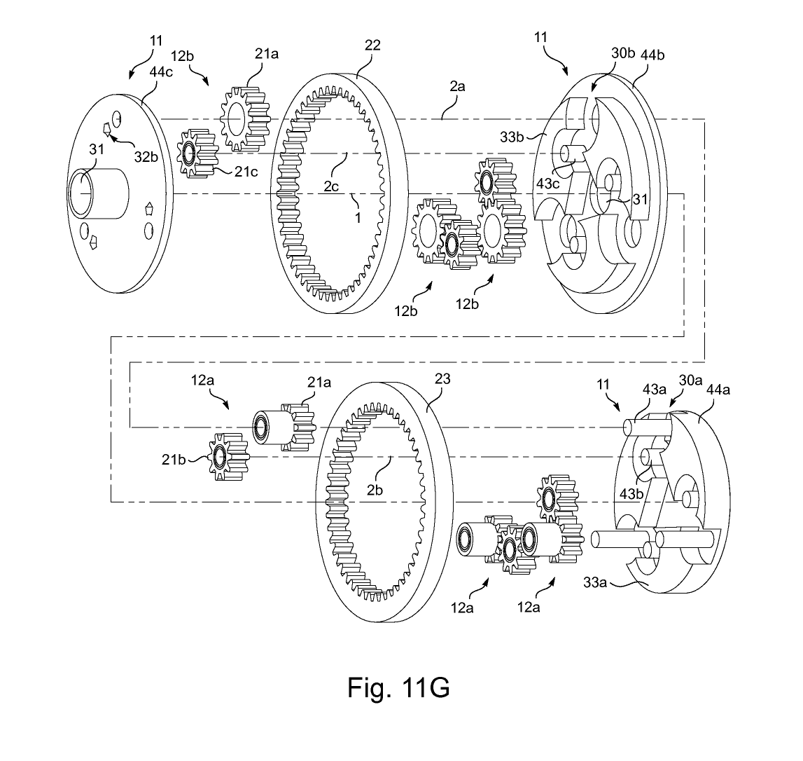

FIG. 11 illustrates a first exemplary embodiment of a dual-stage planetary gear pump 10 which provides flow from a plurality of inlet ports 30, 32 to an outlet port 31 and positive pressure at port 31, when orbit gear 23 is rotated in a particular direction. Reversing the direction of orbit gear 23 provides flow from port 31 to ports 30, 32 and vacuum at port 31. Alternatively, the planetary gear pump 10 may operate as an actuator. Providing positive pressure at port 31 and/or vacuum at ports 30, 32 causes orbit gear 23 to rotate in one direction and providing positive pressure at ports 30, 32 and/or vacuum at port 31 causes orbit gear 23 to rotate in the opposite direction.

The dual-stage planetary gear pump 10 comprises a stationary orbit gear 22, a rotating orbit gear 23, a carrier assembly 11, a plurality of first planet pairs 12a, and a plurality of second planet pairs 12b. The orbit gear 22, orbit gear 23, and carrier assembly 11 are all co-axial and rotatably coupled about a central axis 1. For the sake of simplicity, the rotatable coupling between orbit gear 22, orbit gear 23, and carrier assembly 11 is not depicted in FIG. 11. In practice, orbit gear 22 would be integral with a case and orbit gear 23 and carrier assembly 11 would be rotatably coupled to the case using bearings or other means.

The carrier assembly 11 comprises a first carrier member 44a, a second carrier member 44b, a third carrier member 44c, a plurality of first carrier shafts 43a, each defining a first planet axis 2a, a plurality of second carrier shafts 43b, each defining a second planet axis 2b, and a plurality of third carrier shafts 43c, each defining a third planet axis 2c. All first, all second, and all third carrier shafts 43a, 43b, 43c are parallel to, and spaced uniformly from the central axis 1 with the first carrier shafts 43a spaced further from the central axis 1 than the second and third carrier shafts 43b, 43c.

There are an equal number of first planet pairs 12a, second planet pairs 12b, first carrier shafts 43a, second carrier shafts 43b, and third carrier shafts 43c. Each first planet pair 12a comprises two planet gears 21a, 21b, each co-axial and rotatably coupled to a corresponding planet axis 2a, 2b, by a bearing 61. Each second planet pair 12b comprises two planet gears 21a, 21c, each co-axial and rotatably coupled to a corresponding planet axis 2a, 2c, by a bearing 61.

The first carrier member 44a comprises a plurality of inlet ports 30a and 32a and a plurality of first seals 33a. The second carrier member 44b comprises a plurality of inlet ports 30b, an outlet port 31, and a plurality of second seals 33b. The third carrier member 44c comprises a plurality of inlet ports 32b and an outlet port 31. The first planet pairs 12a comprising planet gears 21a and 21b are sandwiched between the first and second carrier members 44a and 44b with sufficient clearance to prevent a substantial amount of fluid from flowing between the planet gears 21 and the carrier members 44. The second planet pairs 12b comprising planet gears 21a and 21c are sandwiched between the second and third carrier members 44b and 44c with sufficient clearance to prevent a substantial amount of fluid from flowing between the planet gears 21 and the carrier members 44.

In each first planet pair 12a, the first and second planet gears 21a, 21b engage each other, and the first planet gear engages the orbit gear 23. In each second planet pair 12b, the first and second planet gears 21a, 21c engage each other, and the first planet gear engages the orbit gear 22. The first planet gear 21a from each first planet pair 12a is integral with the first planet gear 21a from a corresponding second planet pair 12b.

As illustrated in FIG. 11E, rotating orbit gear 22 in a clockwise direction 7 causes all first planet gears 21a to rotate in a clockwise direction and all second planet gears 21c to rotate in an anti-clockwise direction. The teeth of planet gears 21a and 21c draw fluid in through inlet ports 30b and 32b, and out through outlet port 31. Positive pressure is developed at port 31. The seals 33 follow the circumference of each planet gear 21 to provide resistance to backflow of fluid, particularly when the pump is stationary.

Simultaneously, all first planet gears 21a depicted in FIG. 11F also rotate in a clockwise direction and all second planet gears 21b rotate in an anti-clockwise direction. The teeth of planet gears 21a and 21b draw fluid in through inlet ports 30a and 32a, and out through outlet port 31. Additional positive pressure is developed at port 31. The seals 33 follow the circumference of each planet gear 21 to provide resistance to backflow of fluid, particularly when the pump is stationary.

When the gears are configured with a favorable number of teeth, orbit gear 22 is held stationary, orbit gear 23 is rotated, and the carrier 11 is allowed to rotate freely, the planet gears 21 may rotate at a high speed and provide a very large amount of fluid flow.

In each of the examples described herein, V is the volume of fluid displaced by each turn of the drive shaft 41. A proportionality constant k is defined to represent the volume of fluid contained in the void between gear teeth with a particular geometric profile.

In each exemplary example,

nₚ=number of teeth per planet gear
nₒ=number of teeth per orbit gear
N=number of planet gears
V=volume per pump turn
w=face width
k=profile constant
rₚ=planet gear pitch radius
rₒ=orbit gear pitch radius

A conventional gear pump comprising N=2 planet gears has an outer diameter of 4rₚ. The total volume per turn V delivered by a conventional pump is as follows.

V=2Nmrₚkw=4mrₚkw(cm³/turn)

A conventional gear pump with planet gears similar to those in the fifth exemplary embodiment with nₚ=17 (rₚ=8.5 m) delivers the following volume per turn V.

V=34 m²kw(cm³/turn)

For the fifth exemplary embodiment illustrated in FIG. 5, orbit gear 22 is the input gear and the total volume per turn V₅ delivered is as follows.

V₅=2Nmrₒkw(cm³/turn)

With N=6, nₚ=17 (rₚ=8.5 m) and nₒ=55 (rₒ=27.5 m), the resulting volume per turn V₅ is as follows.

V₅330 m²kw(cm³/turn)

For the fifth exemplary embodiment to have an outer diameter similar to the conventional gear pump with nₚ=17, it must have the following tooth module m′.

4rₚ=34 m=2rₒ=55 m′

m′=0.62 m

For example, the volume per turn V delivered by a conventional gear pump with m=1 and the volume per turn V₅ delivered by the fifth exemplary embodiment with m=0.62 are as follows. Since both pumps have a similar envelope, the fifth embodiment is 3.7 times more space efficient than the conventional gear pump.

V=34kw(cm³/turn)

V₅=126kw(cm³/turn)

For the seventh exemplary embodiment illustrated in FIG. 9, the total volume per turn V₈ delivered is as follows.

V₈=5Nmrₒkw(cm³/turn)

With N=6, nₚ=15 (rₚ=7.5 m) and nₒ=48 (rₒ=24 m), the resulting volume per turn V₈ is as follows.

V₅=720 m²kw(cm³/turn)

For the seventh exemplary embodiment to have an outer diameter similar to the conventional gear pump with nₚ=15, it must have the following tooth module m′.

4rₚ=30 m=2rₒ=48 m′

m′=0.625 m

For example, the volume per turn V delivered by a conventional gear pump with m=1 and the volume per turn V₈ delivered by the seventh exemplary embodiment with m=0.625 are as follows. Since both pumps have a similar envelope, the seventh embodiment is 9.4 times more space efficient than the conventional gear pump.

V=30kw(cm³/turn)

V₅=281kw(cm³/turn)

For a given direction of rotation of the input gear, the direction of fluid flow may be reversed by configuring the planet gears 21 so that planet gear 21b is on the opposite side of the corresponding planet gear 21a. This is illustrated by comparing FIG. 1E to FIG. 4B. The fluid flow 9 is in the same direction in both figures but the direction of the orbit gear 22 is reversed.

In any of the exemplary embodiments, assigning the carrier 44 as the input, as illustrated in FIG. 5, allows scoops 34 to be included which use the carrier rotation to create positive pressure at the inlet ports and reduce slippage.

For the first exemplary embodiment of a dual-stage planetary gear pump illustrated in FIG. 11, orbit gear 22 is the reference, orbit gear 23 is the input, and carrier assembly 11 rotates independently at a rate different from orbit gear 23. The rotation rate of carrier assembly 11 is determined by the associated gear ratio resulting from the particular combination of numbers of teeth in orbit gears 22 and 23 and planet gears 21a-21c.

Alternatively, any planet gear 21 from the first planet pair 12a could be integral with any planet gear 21 from the second planet pair 12b, instead of the two first planet gears 21a from the first and second planet pairs 12a and 12b, as long as the associated axes of the integral gears are aligned.

The exemplary embodiments disclosed herein have a number of advantageous properties. Certain exemplary embodiments may be constructed using moderately sized gears comprising moderate numbers of teeth which are easy to manufacture and have favorable wear properties.

Certain exemplary embodiments may comprise spur gears, helical gears, double helical gears, herring-bone gears, roller tooth gears, conical gears, radial gears, or gears with any other tooth geometry.

Certain exemplary embodiments may comprise rotor pump elements with any number of lobes and any favorable geometry.

Certain exemplary embodiments may be used as a hydraulic pump.

Certain exemplary embodiments may be used as a hydraulic actuator.

Certain exemplary embodiments may be used as a pump which provides a high flow rate for a given envelope.

Certain exemplary embodiments may be used as a pump with a cylindrical envelope that receives fluid from either or both sides of the pump, and delivers it to either or both sides of the pump.

Certain exemplary embodiments may be configured to use a hollow drive shaft as a fluid outlet.

Certain exemplary embodiments restrict fluid flow when the pump is idle.

Certain exemplary embodiments may be used as an actuator which may provide multiple shafts turning at multiple speeds and in the same or different directions.

Certain exemplary embodiments may be used as an actuator with a low shaft velocity and a high pitch velocity providing high torque and low slippage.

Other advantages are apparent from the disclosure herein.

1. An apparatus comprising:
a carrier member, one or more planet pairs, and a central gear;
the carrier member defines a central axis and comprises a first and second plane which are substantially parallel to each other and perpendicular to the central axis;
the space between the first and second plane defines an interior space;
the carrier member further comprises one or more passageways from the exterior of the carrier member to the interior space;
all planet pairs are arranged circumferentially and substantially equally spaced around the central axis;
each planet pair comprises a first planet gear and a second planet gear;
each planet gear is rotatably coupled to the carrier member about a corresponding first or second planet axis;
each planet axis is substantially parallel to the central axis;
the central gear is rotatably coupled to the carrier member about the central axis;
and wherein each first planet gear simultaneously engages the central gear and the second planet gear from the corresponding planet pair.

2. The apparatus of claim 1 wherein each planet gear is sandwiched between the first and second plane.

3. The apparatus of claim 2 further comprising:
a plurality of elongated seal members;
each seal member is integral with the carrier member and extends from the first plane to the second plane;
each seal member comprises one or more semi-circular surfaces describing the circumference of an adjacent gear.

4. The apparatus of claim 1 further comprising:
a plurality of rotors, the number of rotors being equal to the number of planet gears;
each rotor is integral, and configured to rotate in unison with a planet gear;
each rotor is sandwiched between the first and second plane;
and wherein each pair of rotors that are integral with a pair of engaged gears, are also engaged.

5. The apparatus of claim 4 further comprising:
a plurality of elongated seal members;
each seal member is integral with the carrier member and extends from the first plane to the second plane;
each seal member comprises one or more semi-circular surfaces describing the circumference of an adjacent rotor.

6. The apparatus of claim 1 wherein the central gear is a ring gear that encircles all planet gears.

7. The apparatus of claim 6 wherein one or more passageways are located between the central axis and the engagement point between a first and second planet gear.

8. The apparatus of claim 1 wherein the central gear is a pinion gear that is encircled by all planet gears.

9. The apparatus of claim 8 wherein one or more passageways are located between the central gear and the engagement point between a first and second planet gear.

10. The apparatus of claim 3 wherein the number of planet pairs is greater than one and each first planet gear engages the second planet gear from an adjacent planet pair.

11. The apparatus of claim 10 further comprising:
a collection chamber and a plurality of passageways;
the collection chamber comprises a port between the interior and exterior of the collection chamber;
and wherein each passageway joins the engagement point between a pair of engaged gears to the collection chamber.

12. The apparatus of claim 1 further comprising:
a second central gear;
the second central gear is rotatably coupled to the carrier member about the central axis;
the second central gear simultaneously engages all second planet gears.

13. An apparatus comprising:
a carrier member, one or more first planet pairs, an equal number of second planet pairs, a first central gear, and a second central gear;
the carrier member defines a central axis and comprises a first, second, third and fourth plane which are all substantially parallel to each other and perpendicular to the central axis;
the space between the first and second plane define a first interior space;
the space between the third and fourth plane define a second interior space;
the carrier member further comprises one or more passageways from the exterior of the carrier member to the first interior space and one or more passageways from the exterior of the carrier member to the second interior space;
the carrier member further comprises a plurality of elongated seal members, each extending from the first plane to the second plane and comprising one or more semi-circular surfaces describing the circumference of an adjacent gear;
the carrier member further comprises a plurality of elongated seal members, each extending from the third plane to the fourth plane and comprising one or more semi-circular surfaces describing the circumference of an adjacent gear;
all first planet pairs and all second planet pairs are arranged circumferentially and substantially equally spaced around the central axis;
each first planet pair comprises a first planet gear and a second planet gear;
each second planet pair comprises a third planet gear and a fourth planet gear;
each planet gear is rotatably coupled to the carrier member about a corresponding first, second, third or fourth planet axis;
each planet axis is substantially parallel to the central axis;
each central gear is rotatably coupled to the carrier member about the central axis; and wherein
each first and second planet gear is sandwiched between the first and second plane;
each third and fourth planet gear is sandwiched between the third and fourth plane;
each first planet gear simultaneously engages the first central gear and the second planet gear from the corresponding planet pair;
and each third planet gear simultaneously engages the second central gear and the fourth planet gear from the corresponding planet pair.

14. The apparatus of claim 13 wherein each first planet axis is co-axial with a third planet axis and each first planet gear is integral and configured to rotate in unison with the corresponding co-axial third planet gear.

15. The apparatus of claim 13 wherein each first planet axis is co-axial with a fourth planet axis and each first planet gear is integral and configured to rotate in unison with the corresponding co-axial fourth planet gear.

16. The apparatus of claim 13 wherein each second planet axis is co-axial with a fourth planet axis and each second planet gear is integral and configured to rotate in unison with the corresponding co-axial fourth planet gear.

17. A method comprising:
providing a carrier member comprising a first and second plane which are substantially parallel to each other and define a first interior space and further comprising one or more passageways from the exterior of the carrier member to the first interior space;
locating the carrier member on a central axis whereby the first plane is substantially perpendicular to the central axis;
providing one or more first planet pairs, each comprising a first planet gear and a second planet gear;
locating all first planet pairs circumferentially and substantially equally spaced around the central axis, whereby all planet gears are parallel to the central axis and sandwiched between the first and second plane;
rotatably coupling each planet gear to the carrier member about a corresponding first or second planet axis;
providing a first central gear;
rotatably coupling the first central gear to the carrier member about the central axis;
and simultaneously engaging each first planet gear with the first central gear and the second planet gear from the corresponding planet pair.

18. The method of claim 17 further comprising providing a plurality of elongated seal members extending from the first plane to the second plane, each comprising one or more semi-circular surfaces that describe the circumference of an adjacent gear.

19. The method of claim 18 further comprising:
providing at least two first planet pairs;
engaging each first planet gear with the second planet gear from an adjacent planet pair;
providing a collection chamber comprising a port between the interior and exterior of the collection chamber;
and providing a passageway from the engagement point between each pair of engaging gears and the collection chamber.

20. The method of claim 18 further comprising:
providing the carrier member with a third and fourth plane which are substantially parallel to the first plane and define a second interior space and further providing one or more passageways from the exterior of the carrier member to the second interior space;
providing one or more second planet pairs, each comprising a third planet gear and a fourth planet gear;
locating all second planet pairs circumferentially and substantially equally spaced around the central axis, whereby all planet gears are parallel to the central axis and sandwiched between the third and fourth plane;
rotatably coupling each third and fourth planet gear to the carrier member about a corresponding third or fourth planet axis;
providing a second central gear;
rotatably coupling the second central gear to the carrier member about the central axis;
simultaneously engaging each third planet gear with the second central gear and the fourth planet gear from the corresponding planet pair;
and providing a plurality of elongated seal members extending from the third plane to the fourth plane, each comprising one or more semi-circular surfaces that describe the circumference of an adjacent gear.
